(19) United States
(12) Patent Application Publication
(10) Pub. No.: US 2026/0281203 A1
(43) Pub. Date: Sep. 17, 2026

(54) METHOD AND APPARATUS FOR ASSOCIATING NOTIFICATION CHANNEL WITH VAL IDENTITY(S) IN SEAL NOTIFICATION MANAGEMENT SERVICE IN A WIRELESS COMMUNICATION SYSTEM

(71) Applicant: Samsung Electronics Co., Ltd., Gyeonggi-do (KR)

(72) Inventors: Vijay SANGAMESHWARA, Bangalore (IN); Arunprasath RAMAMOORTHY, Bangalore (IN); Basavaraj Jayawant PATTAN, Bangalore (IN)

(21) Appl. No.: 19/472,174

(22) PCT Filed: Apr. 2, 2024
(86) PCT No.: PCT/KR2024/004225

§ 371 Date: Oct. 3, 2025

(30) Foreign Application Priority Data
Apr. 4, 2023 (IN) 202341025557
Mar. 19, 2024 (IN) 202341025557

(51) Int. Cl. H04L 67/55; H04L 9/32; H04L 9/40; H04L 61/3015; H04L 67/306; H04W 12/06

(52) U.S. Cl. CPC H04L 67/55; H04L 9/321; H04L 9/40; H04L 61/3015; H04L 67/306; H04W 12/06

(57) ABSTRACT

The disclosure relates to a 5G or 6G communication system for supporting a higher data transmission rate. The present disclosure discloses methods and devices for notification management in SEAL) services. A SNM client may send a request to create a notification channel for one or more VAL services to a SNM server. The request may comprise at least an identity of the SNM client, channel type, channel validity, and VAL Id cluster list. The VAL Id cluster list comprises one or more VAL Id cluster entry, and wherein each VAL Id cluster comprises at least a VAL user identity, VAL service identity, and VAL application identity. The SNM client further receives, from the SNM server, create notification channel response indicative of successful creation of the notification channel and notifies the VAL client about the successful creation of the notification channel associated with VAL Id cluster list.

### TECHNICAL FIELD

The present invention relates generally to communication networks for notification management and more particularly to methods and devices for associating a notification channel with Vertical Application Layer (VAL) Identity(s) in Service Enabler Architecture Layer (SEAL) notification management Service.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The present disclosure relates to wireless communication systems and, more specifically, the present disclosure relates to associating notification channel with VAL identity in SEAL notification management service.

### Solution to Problem

One or more shortcomings discussed above are overcome, and additional advantages and features are provided by the present disclosure. Other embodiments and aspects of the disclosure are described in detail herein and are considered a part of the disclosure.

On the basis of the limitations as described, the present disclosure addresses the missing functionality, which is about associating the notification channel with VAL Identity(s). In the present disclosure, new VAL Identity cluster information message is disclosed that is shared as part of creating notification channel procedure and associated with notification channel for which the VAL client wants to receive future notification via notification channel.

In an embodiment, a method for notification management in Service Enabler Architecture Layer (SEAL) services being performed by a SEAL Notification Management (SNM) client of a user equipment is disclosed. The method includes receiving, from a Vertical Application Layer (VAL) client, a request to receive notification messages associated from one or more VAL services via a notification channel, sending, to a SNM server, a request to create a notification channel for the one or more VAL services, where the request includes at least an identity of the SNM client, channel type, channel validity, and VAL Id cluster list, where the VAL Id cluster list includes one or more VAL Id cluster entry, and where each VAL Id cluster includes at least a VAL user identity, VAL service identity, and VAL application identity, receiving, from the SNM server, create notification channel response indicative of successful creation of the notification channel, and notifying the VAL client about the successful creation of the notification channel associated with VAL Id cluster list.

In another embodiment, the method may also include where the VAL user identity represents identity of each VAL user associated with the one or more VAL services, the VAL service identity represents identity of each of the one or more VAL services associated with the VAL application, and the VAL application identity represents identity of each VAL application residing in the user equipment and consuming the notification channel. Each of the VAL user identity, the VAL service identity, and the VAL application identity represents a primary key, and where each of the VAL Id cluster represents a super key with combination of all these primary keys, which enables identification of right VAL application, VAL service within the VAL application, and further the VAL user within the application.

In yet another embodiment, the channel type represents one of PULL channel and PUSH channel used for delivering the notification messages.

In yet another embodiment, when the channel type represents the PUSH channel, the request to create the notification channel further comprises PUSH channel details, wherein the PUSH channel details comprise PUSH callback URL to enable the SNM server to push the notification messages.

In yet another embodiment, the method further comprises listening on the PUSH callback URL for receiving the notification messages over the created notification channel from the SNM server based on the VAL Id cluster list and delivering the received notification message to the VAL client on UE based on the VAL ID cluster info associated with notification message.

In yet another embodiment, a method for notification management in Service Enabler Architecture Layer (SEAL) services being performed by a SEAL Notification Management (SNM) server is disclosed. The method includes receiving, from a SNM client, a request to create a notification channel to deliver notifications messages corresponding to one or more Vertical Application Layer (VAL) services associated with a VAL client of a user equipment (UE), where the request includes at least an identity of the SNM client, channel type, channel validity, and VAL Id cluster list, where the VAL Id cluster list includes one or more VAL Id cluster entry, and where each VAL Id cluster includes at least a VAL user identity, VAL service identity, and VAL application identity, and authenticating the identity of the SNM client. The method includes authenticating the identity of the SNM client, processing the received request to create the notification channel upon successful authentication and storing the VAL Id cluster list and sending, to the SNM client, create notification channel response indicative of successful creation of the notification channel.

In yet another embodiment, a user equipment (UE) is disclosed. The UE comprises a SEAL notification management (SNM) client configured to receive, from a Vertical Application Layer (VAL) client, a request to receive notifications messages associated with one or more VAL services via a notification channel, send, to a SNM server, a request to create a notification channel for the one or more VAL services, wherein the request comprises at least an identity of the SNM client, channel type, channel validity, and VAL Id cluster list, wherein the VAL Id cluster list comprises one or more VAL Id cluster entry, and wherein each VAL Id cluster comprises at least a VAL user identity, VAL service identity, and VAL application identity. The SNM client receives, from the SNM server, create notification channel response indicative of successful creation of the notification channel and notify the VAL client about the successful creation of the notification channel.

In yet another embodiment, a SEAL notification management (SNM) server is disclosed. The SNM server comprises a processor configured to receive, from a SNM client, a request to create a notification channel to deliver notifications messages corresponding to one or more Vertical Application Layer (VAL) services associated with a VAL client of user equipment, wherein the request comprises at least an identity of the SNM client, channel type, channel validity, and VAL Id cluster list, wherein the VAL Id cluster list comprises one or more VAL Id cluster entry, and wherein each VAL Id cluster comprises at least a VAL user identity, VAL service identity, and VAL application identity. The processor authenticates the identity of the SNM client and processes the received request to create the notification channel upon successful authentication and storing the VAL Id cluster list. Lastly, the processor sends, to the SNM client, create notification channel response indicative of successful creation of the notification channel.

In yet another embodiment, a method performed by a notification management client in a wireless communication system, the method comprising: transmitting, to a notification management server, a request message associated with creation of a notification channel, the request message including vertical application layer (VAL) identity cluster information; receiving, from the notification management server, a response message as a response to the request message; and receiving, from the notification management server, a notification message associated with the VAL identity cluster information via the notification channel.

In yet another embodiment, a method performed by a notification management server in a wireless communication system, the method comprising: receiving, from a notification management client, a request message associated with creation of a notification channel, the request message including vertical application layer (VAL) identity cluster information; transmitting, to the notification management client, a response message as a response to the request message; receiving, from a VAL server, a notification message associated with the VAL identity cluster information; and transmitting, to the notification management client, the notification message associated with the VAL identity cluster information via the notification channel.

In yet another embodiment, a notification management client in a wireless communication system, the notification management client comprising: a transceiver; and a controller coupled with the transceiver configured to: transmit, to a notification management server, a request message associated with creation of a notification channel, the request message including vertical application layer (VAL) identity cluster information; receive, from the notification management server, a response message as a response to the request message; and receive, from the notification management server, a notification message associated with the VAL identity cluster information via the notification channel.

In yet another embodiment, a notification management server in a wireless communication system, the notification management server comprising: a transceiver; and a controller coupled with the transceiver configured to: receive, from a notification management client, a request message associated with creation of a notification channel, the request message including vertical application layer (VAL) identity cluster information; transmit, to the notification management client, a response message as a response to the request message; receive, from a VAL server, a notification message associated with the VAL identity cluster information; and transmit, to the notification management client, the notification message associated with the VAL identity cluster information via the notification channel.

One or more shortcomings discussed above are overcome, and additional advantages and features are provided by the present disclosure. Other embodiments and aspects of the disclosure are described in detail herein and are considered a part of the disclosure.

### Advantageous Effects of Invention

According to an embodiment of the disclosure, a wireless communication can be performed efficiently. Especially, a reporting SN RACH reports can be performed efficiently.

### BRIEF DESCRIPTION OF DRAWINGS

The accompanying drawings, which are incorporated in and constitute a part of this disclosure, illustrate exemplary embodiments and, together with the description, serve to explain the disclosed principles. Some embodiments of system and/or methods in accordance with embodiments of the present subject matter are now described, by way of example only, and regarding the accompanying figures, in which:

FIG. 1 illustrates a network diagram where the teaching of the of the present disclosure may be implemented in accordance with one or more embodiments of the present disclosure.

FIG. 2 illustrates a VAL Id cluster in accordance with one or more embodiments of the present disclosure.

FIG. 3 illustrates a flowchart of a method for notification management in Service Enabler Architecture Layer (SEAL) services being performed by a SEAL Notification Management (SNM) client (SNM-C) of a user equipment (UE) in accordance with an embodiment of the present disclosure.

FIG. 4 illustrates a method for notification management in Service Enabler Architecture Layer (SEAL) services being performed by a SEAL Notification Management (SNM) server (SNM-S) in accordance with an embodiment of the present disclosure.

FIG. 5 illustrates a call flow diagram for receiving notifications from the notification management server by the notification management client, in accordance with an embodiment of the present disclosure.

It should be appreciated by those skilled in the art that any block diagrams herein represent conceptual views of the illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### MODE FOR THE INVENTION

With increasing applications (APPs) on APP Stores and users devices coming with more processor, memory and other resources etc., have enabled users to install multiple applications for consuming different type of services contrast to the early 2G days, where the users performed just CALL and SMS on their devices. These applications on devices continuously listens to their respective application servers in network to provide real time notifications to users resulting in battery draining, more network traffic and other vulnerabilities.

SEAL Notification Management service (as per 3GPP TS 24.542) defines the notification mechanism to be consumed by application and application server mentioned above. SEAL Notification Management Client (SNM-C) sends create notification channel request to SEAL Notification Management Server (SNM-S) and in case of successful processing the SNM-S shall send response with Notification Server callback associated with SNM-S. The applications on the device shall further share this Notification Server callback to their application servers through which they desire to receive future notification messages.

The information disclosed in this background of the disclosure section is only for enhancement of understanding of the general background of the invention and should not be taken as an acknowledgement or any form of suggestion that this information forms the prior art already known to a person skilled in the art.

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The terms “includes”, “including”, or any other variations thereof, are intended to cover a non-exclusive inclusion, such that a setup, device, or method that includes a list of components or steps does not include only those components or steps but may include other components or steps not expressly listed or inherent to such setup or device or method. In other words, one or more elements in a system or apparatus proceeded by “includes . . . a” does not, without more constraints, preclude the existence of other elements or additional elements in the system or method.

The terms “VAL Client” and “VAL Application” means the same and are interchangeably used in the present disclosure. Further, the “SNM Server” and “SNM-S” are same and are interchangeably used in the present disclosure. Furthermore, the “SNM Client” and “SNM-C” are same and are interchangeably used in the present disclosure.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

With increasing applications on APP stores and user devices coming with more processor, memory and other resources etc. have enabled users to install multiple applications for consuming different type of services contrast to the early 2G days, where the users performed just CALL and SMS on their devices. These applications on devices continuously listen to their respective application servers in network to provide real time notifications to users resulting in battery draining, more network traffic and other vulnerabilities.

The SEAL Notification Management service (3GPP TS 24.542) defines the notification mechanism to be consumed by application and application server mentioned above. SEAL Notification Management Client (SNM-C) sends create notification channel request to SEAL Notification Management Server (SNM-S) and in case of successful processing the SNM-S shall send response with Notification Server callback associated with SNM-S. The applications on the device shall further share this Notification Server callback to their application servers.

In today's time, single sign-on and multiple user accounts are widely used, and this has resulted in serious problems in the SEAL Notification Management service (3GPP TS 24.542 v0.2.0) that needs to be addressed. The notification channel is not associated with any application identities, service identities and user identities. Hence, when the SNM-C receives an incoming notification from the SNM-S, the SNM-C can neither identify the application and application user on the device to whom the notification has to be pushed nor it can broadcast notification messages to all application or application users' that can cause data breach (i.e. notification message may contain confidential information).

In the single sign-on mechanism, the same user-id (user account) may be used across multiple applications. Thus, on receiving notification messages from the SNM-S, the SNM-C is not able to identify the application to which the notification message has to be notified. Further, the single application with multiple User Profiles allows multiple user profiles to be active simultaneously on the same application. For example, user may be active on their personal and business accounts on same application. In such cases, on receiving notification messages from the SNM-S, the SNM-C is not able to identify the particular user profile in the application (i.e. application user) to whom the notification message has to be notified. Further the issue becomes complex when a single application consumes multiple service for providing a feature and notification messages has to be notified to right service in application.

The present disclosure provides solution to the above-mentioned problems by providing a new VAL Identity Cluster message formed by combination of VAL User ID, VAL Service ID and VAL Application ID and by providing updates to create notification channel procedures to associate the notification channel with VAL Identity Cluster(s). The VAL Identity cluster is designed in line with “Super key” followed in a typical database management system. The VAL Identity Cluster is designed as a tuple formed by combination VAL Service ID, VAL Application ID, VAL User ID. Though each member (VAL Service ID, VAL Application ID, VAL User ID) in the VAL Identity Cluster is a primary key by itself, but it is not sufficient to identity the application and a user profile in the application considering modern day applications supporting “Single Sign ON” and “Multiple User Profiles” installed in the user device. But VAL Identity Cluster designed as a “Super Key” with all combination of the primary keys results in unique VAL Identity Cluster that aids in identifying the right application, right service and user profile thus solving the problems. The above defined VAL identity cluster should not considered as limiting. A skilled person would appreciate that the VAL Identity cluster may be enhanced in future to add other identities apart from VAL Service ID, VAL Application ID, VAL User ID based on the requirements, thus combined together serving as a SUPER KEY.

When an application on a user device registers with the SNM-C to receive the future notification messages, the application shares the associated VAL Identity Cluster message and same shall be requested as part of Create Notification channel procedure to the SNM-S. The SNM-S binds the notification channel with VAL Identity cluster. For all future notification messages received from VAL Application servers, the SNMS evaluates with “VAL identity cluster” of each notification channel and the matching channel is used to PUSH the notification messages along with the proposed “VAL identity cluster” that is further utilized by the SNM-C to identify the right “application”, “service within the application” and “user for that application service” where the notification messages has to be notified. In an embodiment, the notification channel between SEAL Notification Management Client (SNM-C) and SEAL Notification Management Server (SNM-S) may be associated with one or more VAL Identity Cluster. In this manner, the present disclosure enables effective notification of incoming messages to the right application, “service within the application” and to correct user profile in the application with just a single or few notification channel between SNM-C and SNM-S.

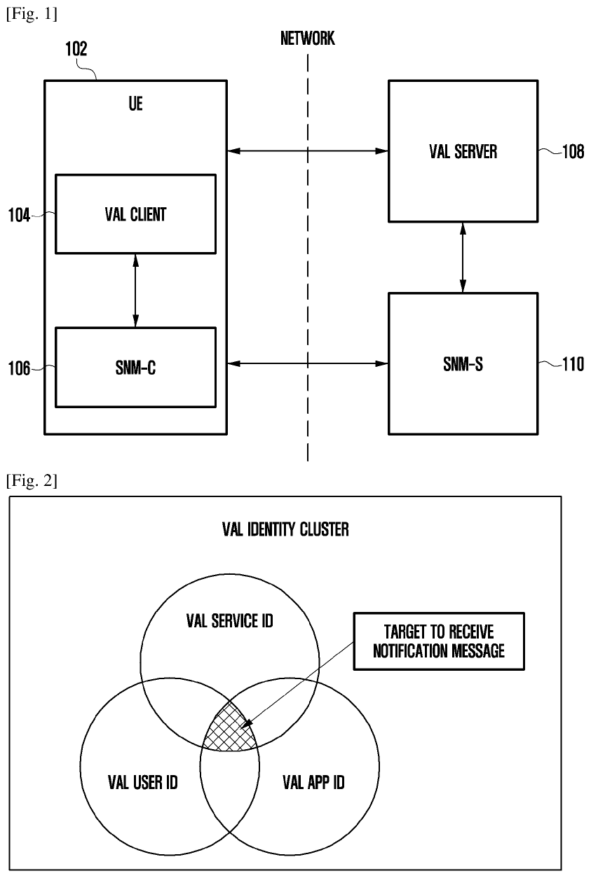

FIG. 1 illustrates a network diagram where the teaching of the present disclosure may be implemented in accordance with one or more embodiments of the present disclosure. As shown in FIG. 1, the network may comprise a user equipment (UE) 102 which may comprise VAL Client 104 and SNM-C 106, but not limited thereto. The UE 102 may be communicatively coupled to a VAL Server 108 and SNM-S 110, but not limited thereto. The UE 102, VAL Server 108 and SNM-S 110 may be coupled to each other over a wired or wireless channel or via a combination thereof. The UE 102 may comprise one or more processing units and storage unit to store various information being exchanged in accordance with various embodiments of the present disclosure. In an embodiment, the SNM-S 110 may also comprise one or more processing unit/processors (not shown in figure) to perform various operations of the SNM-S 110. The SNM-S 110 also comprises a memory device to store the required information. The UE 102 may comprise one or more VAL applications installed therein. In an embodiment, each application may avail different service such as call service, text service, game service, etc., but not limited thereto.

According to an embodiment, the SEAL notification management (SNM) client (SNM client or SNM-C) 106 may receive a request to receive notifications messages associated with one or more VAL services via a notification channel, from the VAL Client 104. Upon receiving the request from the VAL Client 104, the SNM-C 106 may send a request message to the SNM-S 110 for creating a notification channel for the one or more VAL services, as specified in Table-1. The request sent to the SNM-S 110 may comprise at least an identity of the SNM client, channel type, channel validity, and VAL Id cluster list, but not limited thereto. The VAL Id cluster list comprises one or more VAL Id cluster entries, where each VAL Id cluster comprises at lcast a VAL user identity, VAL service identity, and VAL application identity. In an embodiment, the VAL user identity represents the identity of each VAL user associated with the one or more VAL services. Further, the VAL service identity represents identity of each of the one or more VAL services associated with the VAL application, and the VAL application identity represents identity of each VAL application reside in the user equipment and consuming the notification channel. Each of the VAL user identity, the VAL service identity, and the VAL application identity represents a primary key, and the VAL Id cluster represents a super key with combination of all the primary keys. The VAL Id cluster enables identification of right VAL application, right VAL service and VAL user. FIG. 2 represents a VAL Id cluster in accordance with one or more embodiments of the present disclosure.

TABLE 1
Client side parameters for create notification channel request

| Parameter | Description |
|---|---|
| Requestor | REQUIRED. Represents the identity of the notification |
| identity | management client. |
| Channel | REQUIRED. Represents PULL or PUSH method to be |
| type | used for delivering the notification messages. |
| | - 0 × 01: PUSH TYPE |
| | - 0 × 02: PULL TYPE |
| PUSH | OPTIONAL. Represents details of the type of PUSH |
| channel | delivery and its associated data as specified in table-2. |
| details | |
| Expiry | REQUIRED. Represents the duration the notification |
| Time | channel shall be active (i.e. channel lifetime) as requested |
| | by the notification management client. |
| VAL Id | REQUIRED. Represents the list of VAL identities |
| Cluster | corresponding to the VAL services as specified in table-3. |
| List | |

TABLE 2
PUSH channel details information

| Parameter | Description |
|---|---|
| PUSH | REQUIRED. Represents PUSH call back URL where |
| Callback- | the SNM-S shall push the notification messages |
| URL | received by the VAL server. |

TABLE 3
VAL Identity Cluster Info

| Parameter | Description |
|---|---|
| VAL User | REQUIRED. Represents the identity of VAL user |
| Identity | within the VAL service. |
| VAL | REQUIRED. Represents the Identify of the VAL |
| Service | service. |
| ID | |
| VAL | REQUIRED. Represents the Identity of the VAL |
| Application | application residing in the VAL UE. |
| ID | |

Upon receiving the request, the SNM-S 110 may authenticate the identity of the SNM client. Upon successful authentication, the SNM-S 110 processes the received request to create the notification channel upon successful authentication and storing the VAL Id cluster list and creates the channel as required. The SNM-S 110 sends create notification channel response to the SNM client. Thus, in response to the request sent to the SNM-S 110, the SNM-C 106 receives create notification channel response (as specified in Table-4), from the SNM server, which is indicative of successful creation of the notification channel. The SNM-C 106 may notify the VAL Client 104 about the successful creation of the notification channel. In an embodiment, the create notification channel response comprises at least callback URL and identifier of the notification channel. The callback URL represents a URL associated with notification channel on the SNM-S 110 side to be notified to the VAL Client 104 by the SNM-C 106 to enable the VAL Client 104 to share the callback URL with VAL Server 108 while subscribing for the one or more VAL services.

TABLE 4
Server side parameters for create notification channel response

| Parameter | Description |
|---|---|
| Notification | OPTIONAL. Represents the URL that shall be used by |
| URL | SNM-C to pull notification if the channel type is PULL. |
| Callback | REQUIRED. Represents the URL, which shall be |
| URL | notified to VAL client by SNM-C. Further this URL |
| | shall be shared by VAL client to VAL server |
| | while subscribing for a VAL services. |
| Channel | REQUIRED. Represents the identifier of the newly |
| Identifier | created notification channel. |
| Expiry | OPTIONAL. Represents the duration the notification |
| Time | channel shall be active (i.e. channel lifetime) as requested |
| | by the notification management client. |

In an embodiment, the channel type represents one of PULL channel and PUSH channel used for delivering the notification messages. When the channel type represents the PUSH channel, the request to create the notification channel further comprises PUSH channel details. The PUSH channel details comprise PUSH callback URL associated with notification channel on SNM client side to enable the SNM server to push the notification messages. Upon receiving such details, the SNM-S 110 stores the PUSH channel details for future usage when the notification messages need to be pushed to the SNM client.

Further, the SNM-C 106 listens on the PUSH callback URL for receiving the notification messages over the created notification channel from the SNM server based on the VAL Id cluster list. The SNM-C 106 delivers the received notification message to the VAL client on UE based on the VAL ID cluster info associated with notification message. Further, when the channel type represents the PULL channel, the SNM client may fetch the notification messages from the SNM server over the created notification channel and may use the VAL identity cluster associated with the notification message to deliver these fetched notification messages to the VAL client.

In another embodiment, to send the PUSH notification messages received from the VAL Server 108 to the SNM-C 106, the SNM-S 110 checks whether an PUSH notification channel exists with the SNM-C 106 to receive the notification messages matching to the VAL identities (VAL UE or VAL user ID, VAL service ID, VAL application ID) shared by VAL Server 108. Thereafter, the SNM-S 110 generates an HTTP POST message to send notification messages received from the VAL Server 108. In the HTTP POST message sets request URI to the call back URI received at the time of creating channel and generates the notification message payload as specified in Table-5. The SNM-S 110 sets the channel identifier associated with the SNM-C 106 and generates the notification message list for the message received from VAL servers, as specified in Table-5. Thereafter, the SNM-S 110 sends the HTTP POST request towards SNM-C.

TABLE 5
parameters for notification message payload

| Parameter | Description |
|---|---|
| Channel | REQUIRED. Represents the identifier of the notification |
| Identifier | channel corresponding to the SNM-C. |
| VAL | REQUIRED. Represents a list of notification messages. |
| Notification | Each notification message represents the message |
| Message | received from VAL servers which is encoded by SNM-S |
| List | as specified in table-6. |

TABLE 6
VAL Notification Message

| Parameter | Description |
|---|---|
| VAL Id | REQUIRED. Represents the VAL identities shared |
| Cluster Info | by VAL server along with the VAL notification |
| | message which is encoded as specified in table A. |
| | 1.2-3. |
| VAL Notification | REQUIRED. Represents the content type of the |
| Message Type | VAL notification message as shared by the VAL |
| | server. |
| VAL Notification | REQUIRED. Represents the length of the VAL |
| Message Length | notification message. |
| VAL Notification | REQUIRED. Represents the message received |
| Message | from the VAL server to be notified to the SNM-C. |

Upon receiving a request over a call back URI which was given to the SNM-S at the time of notification channel creation, the SNM-C may match identifier received in the channel identifier parameter of the request with the locally stored channel identifier. If the channel identifier is not matching, then the SNM-C 106 sends a negative response to the SNM-S 110. Otherwise, the SNM-C 106 sends a OK response to the SNM-S 110 and process the VAL notification message list parameter received in the request entity-body as specified in table-6 and deliver each received notification message to the appropriate VAL client on the UE 102 that matches the VAL Id cluster info parameter received with each message.

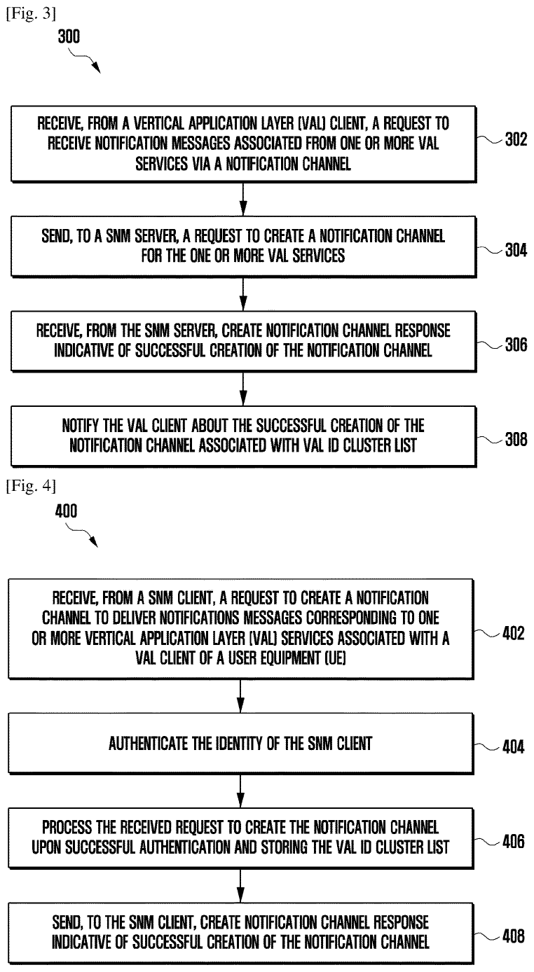

FIG. 3 illustrates a flowchart of a method for notification management in Service Enabler Architecture Layer (SEAL) services being performed by a SEAL Notification Management (SNM) client (SNM-C) 106 of a user equipment (UE) 102 in accordance with an embodiment of the present disclosure. In block 302, the method 300 receives, from a Vertical Application Layer (VAL) Client 104, a request to receive notification messages associated from one or more VAL services via a notification channel. In block 304, the method 300 sends, to a SNM VAL Server 108, a request to create a notification channel for the one or more VAL services. The request comprises at least an identity of the SNM client, channel type, channel validity, and VAL Id cluster list, but not limited thereto. The VAL Id cluster list may comprise one or more VAL Id cluster entries. Each VAL Id cluster comprises at least a VAL user identity, VAL service identity, and VAL application identity.

In an embodiment, the VAL user identity represents the identity of each VAL user associated with the one or more VAL services. The VAL service identity represents identity of each of the one or more VAL services associated with the VAL application and the VAL application identity represents identity of each VAL application residing in the user equipment and consuming the notification channel. Each of the VAL user identity, the VAL service identity, and the VAL application identity represents a primary key, and each of the VAL Id cluster represents a super key with combination of all these primary keys. The VAL Id cluster enables identification of the right target VAL application, VAL service within the VAL application and further the VAL user with in the application.

In another embodiment, the channel type is one of PULL channel and PUSH channel used for delivering the notification messages. When the channel type represents the PUSH channel, the request to create the notification channel further comprises PUSH channel details. The PUSH channel details comprise PUSH callback URL associated with notification channel on the SNM client 106 side to enable the SNM VAL Server 108 to push the notification messages. Further, in block 306, the method 300 receives, from the SNM VAL Server 108, create notification channel response indicative of successful creation of the notification channel. In block 308, the method 300 notifies the VAL Client 104 about the successful creation of the notification channel associated with VAL Id cluster list.

The method 300 further comprises listening on the PUSH callback URL for receiving the notification messages over the created notification channel from the SNM VAL Server 108 based on the VAL Id cluster list. Upon receiving the notification, the SNM-C 106 delivers the received notification message to the VAL Client 104 on UE 102 based on the VAL ID cluster info associated with notification message. Furthermore, when the channel type represents the PULL channel, the SNM-C 106 fetches the notification messages from the SNM server over the created notification channel and delivers the fetched notification messages to the VAL Client 104 on UE 102 based on the VAL ID cluster info associated with notification message.

FIG. 4 illustrates a method for notification management in Service Enabler Architecture Layer (SEAL) services being performed by a SEAL Notification Management (SNM) server (SNM-S) 110, in accordance with an embodiment of the present disclosure. In block 402, the method 400 recites receiving, from the SNM client 106, a request to create a notification channel to deliver notifications messages corresponding to one or more Vertical Application Layer (VAL) services associated with the VAL Client 104 of the UE 102. The request comprises at least an identity of the SNM client, channel type, channel validity, and VAL Id cluster list. The VAL Id cluster list may comprise one or more VAL Id clusters. Each VAL Id cluster comprises at least a VAL user identity, VAL service identity, and VAL application identity. In an embodiment, the VAL user identity represents identity of each VAL user associated with the one or more VAL services. The VAL service identity represents identity of each of the one or more VAL services associated with the VAL application and the VAL application identity represents identity of each VAL application residing in the user equipment and consuming the notification channel. Each of the VAL user identity, the VAL service identity, and the VAL application identity represents a primary key, and each of the VAL Id cluster represents a super key with combination of all these primary keys. The VAL Id cluster enables identification of right VAL application, VAL service within the VAL application and further the VAL user with in the application.

In another embodiment, the channel type is one of PULL channel and PUSH channel used for delivering the notification messages. When the channel type represents the PUSH channel, the request to create the notification channel further comprises PUSH channel details. The PUSH channel details comprise PUSH callback URL associated with notification channel on the SNM client 106 side to enable the SNM VAL Server 108 to push the notification messages. The method 400 further comprises storing the PUSH channel details for future usage when the notification messages need to be pushed to the SNM client.

In block 404, the method 400 authenticates the identity of the SNM client. In block 406, the method 400 recites processing the received request to create the notification channel upon successful authentication and storing the VAL Id cluster list. In block 408, the method 400 recites sending, to the SNM-C 106, create notification channel response indicative of successful creation of the notification channel. In an embodiment, the create notification channel response comprises at least callback URL and identifier of the notification channel. The callback URL represents a URL to be notified to the VAL Client 104 by the SNM-C 106 to enable the VAL Client 104 to share the callback URL with VAL Server 108 while subscribing for the one or more VAL services.

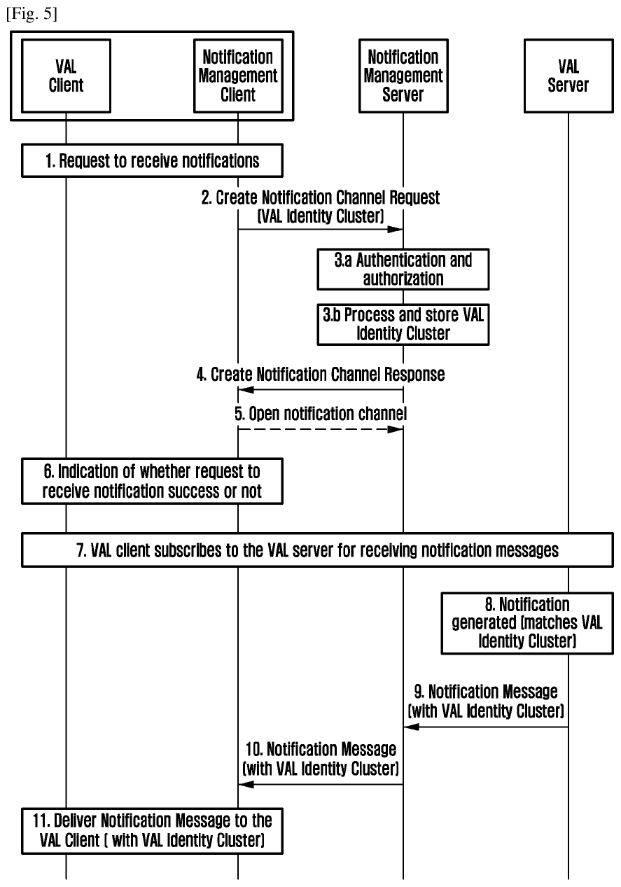

FIG. 5 illustrates a call flow diagram for receiving notifications from the notification management server by the notification management client, in accordance with an embodiment of the present disclosure. At step 1, the VAL Client 104 may request the notification management client (SNM-C 106) to subscribe to and receive notifications from the VAL Server 108. At step 2, the SNM-C 106 creates notification channels (i.e. endpoint URLs), if not created already, to be used by the VAL server to send notification messages. To create notification channel, the SNM-C 106 sends a create notification channel request to the notification management server (SNM-S) 110. The desired validity duration for the channels to be used and the notification channel type (i.e., PUSH or PULL) are included in the request. The SNM-C 106 decides which type of the notification channel to be used based on the UE capability. In an embodiment, the SNM-C 106 also includes the VAL Identity cluster message that shall be associated with the notification channel for which the VAL Client 104 wants to receive future notification via notification channel.

At step 3, the SNM-S 110 authenticates the notification management client and authorizes its request. At step 4, the SNM-S 110 sends the SNM-C 106 the Create notification channel response with the endpoint URLs that will be used by the VAL Server 108 to send the notification messages and the SNM-C 106 to receive the notification messages. The SNM-S 110 also includes what is the valid duration for these endpoint URLs to be used and the channel ID to uniquely identify the channel created in the response. The SNM-S 110 shall store the VAL Identity cluster message received, to ensure future notification messages addressed to the SNM-C 106 shall be sent only when they are mapped in VAL Identity cluster.

At step 5, if the notification type is PULL method, the SNM-C 106 sends the Open notification channel to the SNM-S 110 to start receiving the notification message. For certain PUSH method notification type (such as WebSockets), the SNM-C 106 requests the SNM-S 110 to start the PUSH notification service with its specific protocol that is outside the scope of this specification. This step is not required if the SNM-C 106 wants to receive the notification messages via PUSH notification server 110. At step 6, the SNM-C 106 responds to the VAL Client 104 the status of its request as in step 1 to receive notifications from the VAL Server 108. It also includes the callback URL which needs to be used by the VAL Client 104 while subscribing to the VAL Server 108 for receiving notifications.

At step 7, the VAL Client 104 subscribes to the VAL Server 108 for receiving notifications. This request includes the subscription data and the callback URL returned from the notification management server 110 in step 4. Further, at step 8, the VAL Server 108 generates the notification message for the subscription request from the VAL Client 104. The VAL Server 108 sends the notification message to the notification management server 110 containing the VAL UE or VAL user ID, VAL service ID, VAL application ID and the notification data, at step 9.

At step 10, if the delivery method is PULL, the notification management server 110 sends the notification message to the SNM-C 106 over the opened notification channel. If the delivery method is PUSH via PUSH notification server, the SNM-S 110 sends the notification message to the OEM Push server (not shown in the figure) to deliver to the SNM-C 106. At step 11, the SNM-C 106 delivers the received notification message to the appropriate VAL Client 104 based on the details as received in the notification message from the notification management server SNM-S 110.

Although, the above-mentioned method/technique are disclosed considering the scenario that notification channel does not exists, however in case of an existing active notification channel, the SNM-C 106 perform UPDATE procedure to associate the existing notification channel with the VAL cluster identity rather than performing CREATE procedures to create a new notification channel.

In this manner, the present disclosure updates to existing create notification channel procedure. Since the notification channel as per existing art was created without any association with respect to Application ID, Service ID, User ID, the association of these IDs is very important to clearly identify the right target application, service within the application and the user of the application service who shall consume the notification message. The present disclosure enables the SNM-C to associate VAL identities to a notification channel created as part of create notification channel procedures to the SNM-S in a very simple way and also discloses message formats to carry VAL identities proposed as VAL Cluster identities. Without the disclosed techniques, the notification messages received on notification channel doesn't carry any address to whom it has to be notified. The teachings of the present disclosure are applicable to 5G, 5G Advanced and 6G, but not limited thereto.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the detailed description. The order in which the various operations of the methods are described is not intended to be construed as a limitation, and any number of the described method blocks can be combined in any order to implement the method. Additionally, individual blocks may be deleted from the methods without departing from the spirit and scope of the subject matter described herein. Furthermore, the methods can be implemented in any suitable hardware, software, firmware, or combination thereof.

It may be noted here that the subject matter of some or all embodiments described with reference to FIGS. 1-5 may be relevant for the methods and the same is not repeated for the sake of brevity.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in Figures, those operations may be performed by any suitable corresponding counterpart means-plus-function components.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., nontransitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a”, “an” and “the” mean “one or more”, unless expressly specified otherwise. The terms “including”, “comprising”, “having” and variations thereof, when used in a claim, is used in a non-exclusive sense that is not intended to exclude the presence of other elements or steps in a claimed structure or method, unless expressly specified otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present disclosure are intended to be illustrative, but not limiting, of the scope of the invention, which is set forth in the appended claims.

1. A method performed by a notification management client in a wireless communication system, the method comprising:
transmitting, to a notification management server, a request message associated with creation of a notification channel, the request message including vertical application layer (VAL) identity cluster information;
receiving, from the notification management server, a response message as a response to the request message; and
receiving, from the notification management server, a notification message associated with the VAL identity cluster information via the notification channel.

2. The method of claim 1,
the response message including at least one of a duration associated with the notification channel, a unique channel identifier, or a uniform resource locator (URL) that will be used by the notification management client.

3. The method of claim 1,
wherein the VAL identity cluster information includes at least one of a VAL user identity, a VAL service identity, or a VAL application identity.

4. The method of claim 1,
wherein an authentication of the notification management client is performed, based on the request message associated with the creation of the notification channel.

5. A method performed by a notification management server in a wireless communication system, the method comprising:
receiving, from a notification management client, a request message associated with creation of a notification channel, the request message including vertical application layer (VAL) identity cluster information;
transmitting, to the notification management client, a response message as a response to the request message;
receiving, from a VAL server, a notification message associated with the VAL identity cluster information; and
transmitting, to the notification management client, the notification message associated with the VAL identity cluster information via the notification channel.

6. The method of claim 5,
the response message including at least one of a duration associated with the notification channel, a unique channel identifier, or a uniform resource locator (URL) that will be used by the notification management client.

7. The method of claim 5,
wherein the VAL identity cluster information includes at least one of a VAL user identity, a VAL service identity, or a VAL application identity.

8. The method of claim 5, further comprising:
performing an authentication of the notification management client, based on the request message associated with the creation of the notification channel.

9. A notification management client in a wireless communication system, the notification management client comprising:
a transceiver; and
a controller coupled with the transceiver configured to: transmit, to a notification management server, a request message associated with creation of a notification channel, the request message including vertical application layer (VAL) identity cluster information;
receive, from the notification management server, a response message as a response to the request message; and
receive, from the notification management server, a notification message associated with the VAL identity cluster information via the notification channel.

10. The notification management client of claim 9,
the response message including at least one of a duration associated with the notification channel, a unique channel identifier, or a uniform resource locator (URL) that will be used by the notification management client.

11. The notification management client of claim 9,
wherein the VAL identity cluster information includes at least one of a VAL user identity, a VAL service identity, or a VAL application identity.

12. The notification management client of claim 9,
wherein an authentication of the notification management client is performed, based on the request message associated with the creation of the notification channel.

13. A notification management server in a wireless communication system,
the notification management server comprising:
a transceiver; and
a controller coupled with the transceiver configured to:
receive, from a notification management client, a request message associated with creation of a notification channel, the request message including vertical application layer (VAL) identity cluster information;
transmit, to the notification management client, a response message as a response to the request message;
receive, from a VAL server, a notification message associated with the VAL identity cluster information; and
transmit, to the notification management client, the notification message associated with the VAL identity cluster information via the notification channel.

14. The notification management server of claim 13,
the response message including at least one of a duration associated with the notification channel, a unique channel identifier, or a uniform resource locator (URL) that will be used by the notification management client, and
wherein the VAL identity cluster information includes at least one of a VAL user identity, a VAL service identity, or a VAL application identity.

15. The notification management server of claim 13, the controller is further configured to:
perform an authentication of the notification management client, based on the request message associated with the creation of the notification channel.
